(19) United States
(12) Patent Application Publication
(10) Pub. No.: US 2012/0133494 A1
(43) Pub. Date: May 31, 2012

(54) Systems and Methods for Providing Programmable Deformable Surfaces

(75) Inventors: Juan Manuel Cruz-Hernandez, Montreal (CA); Andrew Gosline, Cambridge, MA (US)

(73) Assignee: Immersion Corporation, San Jose, CA (US)

(21) Appl. No.: 12/955,186

(22) Filed: Nov. 29, 2010

(51) Int. Cl. G08B 6/00; H04B 3/36

(52) U.S. Cl. 340/407.2; 340/407.1

(57) ABSTRACT

Programmable deformable surfaces can use smartgels that respond to external stimuli by changing in stiffness, volume, and/or transparency or color. A device can include a smartgel in one or more cells of a tactile layer, such as a layer of material positioned over a display device visible through the layer. Portions of the tactile layer can be subjected to one or more stimuli, such a change in temperature that causes areas of smartgel to deform, to provide haptic feedback. For example, wires can be embedded in the tactile layer and/or between the tactile layer and the display and by controlling current passing through the wires, portions of the tactile layer can be subjected to changes in temperature, such as to raise/lower portions of the tactile layer at a location corresponding to an object in a graphical user interface when a touch occurs at or near the location.

### FIELD OF THE INVENTION

The present invention generally relates to providing programmable deformable surfaces and more specifically relates to providing programmable deformable surfaces using smartgels.

### BACKGROUND

Computing devices increasingly rely on the use of touch-sensitive surfaces to receive user input. For example, touch-enabled displays are popular for use in computing devices, and particularly for use in mobile devices such as mobile telephones, tablet computers, media players, and the like. Other touch-enabled devices such as mice, trackpads, and the like may also be used even if a touch-enabled display is not provided. Although touch-enabled devices are popular for use in receiving input, most existing systems rely on visual output, sometimes augmented by other feedback such as sound or vibration.

### SUMMARY

Embodiments include systems and methods for providing programmable deformable surfaces using smartgels that respond to a stimulus or stimuli by changing in stiffness, volume, and/or transparency or color. Haptic feedback, such as tactile feedback provided by deforming a surface, can be used to enhance a user's experience of a touch-enabled device.

As an example, a device can include a smartgel in one or more cells of a tactile layer, such as a layer of material positioned over a display device visible through the layer. Portions of the tactile layer can be subjected to changes in temperature that cause areas of smartgel to deform. For example, one or more wires can be embedded in the tactile layer and/or between the tactile layer and the display. By controlling current passing through the wires, portions of the tactile layer can be subjected to changes in temperature in response to events. The resulting deformation can raise or lower portions of the tactile layer at a location corresponding to an object in a graphical user interface when a touch occurs at or near the location.

This illustrative embodiment is mentioned not to limit or define the invention but rather to provide an example to aid understanding thereof. Illustrative embodiments are discussed in the Detailed Description, where further description of the invention is provided. The advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 shows an embodiment of a system for providing programmable deformable surfaces.

FIG. 2 is a diagram of another illustrative embodiment of a system for providing programmable deformable surfaces.

FIGS. 3A-3B illustrate an example of a tactile layer before and after deformation to provide a tactile effect.

FIG. 4 is a flowchart showing steps in an illustrative method of providing a programmable deformable surface.

FIG. 5 is a flowchart showing steps in an illustrative method of providing a haptic effect using a programmable deformable surface.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure include modifications and variations as come within the scope of the appended claims and their equivalents.

### Illustrative Programmable Deformable Surface

In one illustrative embodiment of the present invention, a system for providing programmable deformable surfaces comprises a conventional cellular telephone or other mobile device having a touch-sensitive display screen. Such a device allows a user to touch the screen to interact with a graphical user interface displayed on the screen, to place phone calls, draft and send text messages, and perform other actions.

In this illustrative embodiment, the display screen is covered by a translucent overlay having a translucent smartgel embedded within it. In addition, the overlay also has multiple small wires embedded within it. The wires are shaped to correspond with frequently displayed objects in the graphical user interface, such as buttons corresponding to digits on a keypad, buttons corresponding to keys on a keyboard, and buttons for common functions such as starting and ending phone calls, or sending text messages. In this illustrative embodiment, the wires are sized or configured to be invisible or nearly invisible to a user viewing the display screen through the overlay.

Each of the wires is connected to an amplifier, which is connected to a processor. The processor is configured to send signals to the amplifier to generate currents within one or more of the wires. As current flows through a wire, the wire provides a stimulus—in this example, by emitting thermal energy (i.e. heat). The heat is at least partially absorbed by the smartgel in the overlay at locations where the one or more wires are in close proximity to or contacting the smartgel.

In this example, the smartgel is configured to expand and to stiffen when it reaches a temperature of approximately 29 degrees Celsius and continues to expand and stiffen until it reaches a temperature of approximately 35 degrees Celsius. Thus, as the wires heat parts of the smartgel, those parts of the smartgel expand and stiffen, while other parts of the smartgel remain unaffected. The expanded, stiff parts of the smartgel provide textures that may be felt by a user when she touches the overlay on the display screen. If wires corresponding to visible graphical user interface objects are activated, the user can feel outlines around some or all of the various objects displayed on the screen. When the screen changes configurations, different wires may be activated to change the feel of the screen. Thus, this illustrative embodiment of the present invention is capable of affecting the apparent texture of the screen to correspond to features displayed on the screen, thus providing a richer user experience.

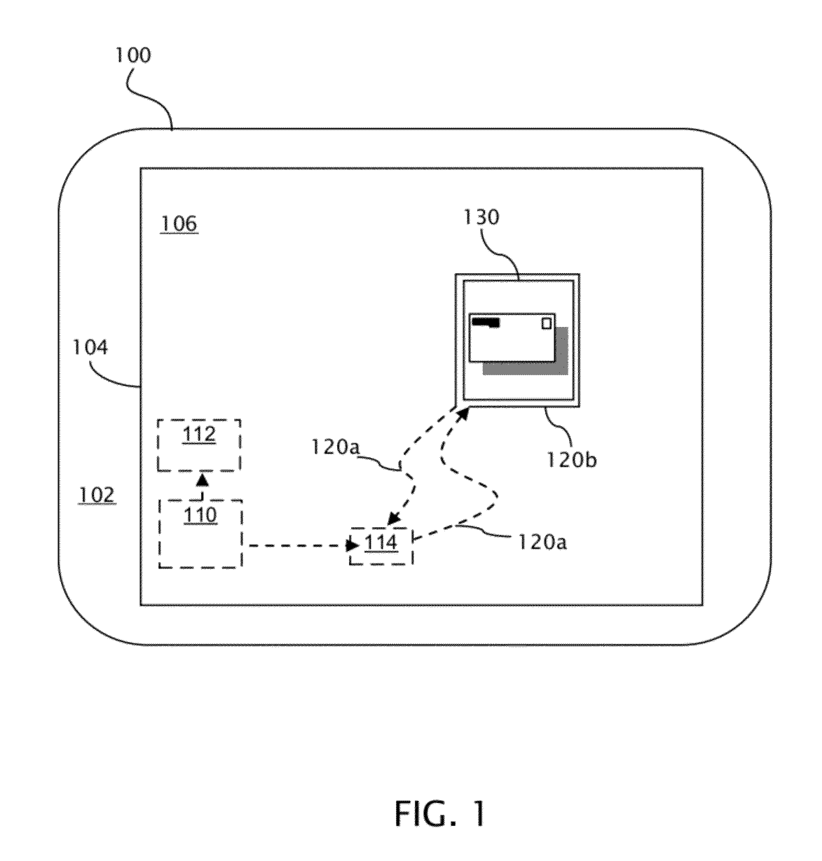

Referring now to FIG. 1, FIG. 1 shows a system for providing programmable deformable surfaces according to one embodiment of the present invention. In the embodiment shown in FIG. 1, the system comprises a handheld device 100 having a housing 102. Disposed within the housing are a display 104 having a tactile layer 106 comprising a smartgel and overlaying display 104. The system further comprises a processor 110, a memory 112, an amplifier 114 and a wire 120. In the embodiment shown in FIG. 1, the display 104 is displaying a user interface button 130 that a user may select to activate an email program.

In the embodiment shown in FIG. 1, several components are shown with dashed outlines. The dashed lines in FIG. 1 indicate a structure that is disposed within the housing 102 and is not visible to a user of the device 100. In contrast, several components are outlined with solid lines. Such components are visible to a user of the device. In some embodiments, however, different components may be visible or not visible to a user of the device.

As shown in FIG. 1, tactile layer 106 comprises a smartgel embedded at one or more locations, such as within one or more cells in layer 106. In the embodiment shown, the smartgel comprises a temperature-sensitive hydrogel. The hydrogel is configured to expand (or swell) and stiffen when heated above a first threshold temperature and to continue to expand and stiffen until reaching a second threshold temperature. The hydrogel is further configured to contract (or deswell) and relax when cooled down below the second threshold temperature until it reaches the first threshold temperature. For the purposes of this disclosure, a “transition temperature” refers to a temperature between the first and second threshold temperatures, and a “transition temperature range” refers to the range between the first and second thresholds.

A “smartgel” is meant to include any of the class of hydrogels that retain a stable shape that change at least one of volume or stiffness in response to an external stimulus, such as a change in temperature. Suitable hydrogels include, but are not limited to, temperature-sensitive hydrogels of poly(N-isopropylacrylamide) (PNIPAAm). Polymer networks of poly(acrylic acid) (PAA) and polyacrylamide (PAAm) or poly(acrylamide-co-butyl methacrylate) have positive temperature dependence of swelling. The most commonly used thermoreversible gels are these prepared from poly(ethylene oxide)-b-poly(provpylene oxide)-b-poly(ethylene oxide). Of course, other smartgels can be used in conjunction with one or more stimuli other than temperature.

These and other examples of stimuli-sensitive hydrogels are discussed by Masteikova et al. in the article, “Stimuli-sensitive hydrogels in controlled and sustained drug delivery,” Medicina (2003) 39 tomas, 2 priedas (pages 19-24), which is incorporated by reference herein in its entirety and includes discussion of various hydrogels at pages 19-20. Additional description of smart gels can be found in Chaterji et al., “Smart polymeric gels: Redefining the limits of biomedical devices,” Prog. Polym. Sci. 32 (2007), 1083-1122, which is incorporated by reference herein in its entirety and includes discussion of gels on the basis of stimuli at page 1095-1108.

In the embodiment shown in FIG. 1, the smartgel is configured to have a transition temperature range between approximately 29 degrees Celsius and 35 degrees Celsius. The smartgel is further configured to become less translucent (i.e. more opaque) as the temperature of the smartgel increases in the transition temperature range. In the embodiment shown in FIG. 1, the system is configured to increase the temperature of the smartgel in one or more locations by transferring thermal energy generated by electrical current flowing through wires 120 in close proximity or contacting the smartgel, as is described in more detail below.

Processor 110 is configured to execute program code stored in memory 112 to determine when to provide current through wires 120. Various types of processors and memories are discussed in more detail below. In the embodiment shown in FIG. 1, the processor 110 is in communication with the wire 120 via the amplifier 114 and is configured to generate a signal that causes an electrical current to flow through the wire 120. The signal is sent from the processor to the amplifier 114, such as via an onboard D/A converter or output part, with the amplifier actually generating sufficient current to be sent through the wire 120. However, in some embodiments, the processor 110 may be configured to directly generate the current by directly coupling to the wire 120.

The wire 120 has a portion 120b that has been configured to outline a virtual button to be displayed as a part of a user interface. Portion 120b has been disposed in the housing such that it contacts the smartgel disposed within the overlay 102. However, the wire 120 also has a portion 120a that is disposed such that it does not contact the smartgel within the overlay 102. Thus, when current flows through the wire 120, the wire emits thermal energy. The close proximity of portion 120b to the overlay 102 causes the smartgel to absorb the thermal energy and deform. However, the other portion 120a of the wire 120 is disposed such that, even though it emits thermal energy, thermal energy dissipates sufficiently so that it does not cause the smartgel to deform.

As discussed above, as current flows through the wire 120, the thermal energy in portion 120b is absorbed by the smartgel 106 and increases the temperature of the smartgel in locations corresponding to the location of portion 120b. The increase in temperature of the smartgel in such locations is based on the amount of current flowing through portion 120b. As more current flows through the wire 120, and portion 120b, more thermal energy is generated and radiated, causing a greater temperature increase in the smartgel 106. When the temperature of the smartgel exceeds the first threshold (29 degrees Celsius in this embodiment), the smartgel begins to swell and stiffen. Thus, to create a deformed surface feature based on wire 120, sufficient current must be passed through wire 120 to heat the smartgel 106 to a transition temperature or hotter.

In this example, smartgel 106 is selected to expand when the temperature exceeds the first threshold. However, embodiments may additionally or alternatively use a smartgel 106 that contracts when the temperature exceeds the first threshold. For example, the overlay may be configured with areas of spacers (i.e., non-smart gel material) adjacent to areas having smart gel material. When the smartgel is heated and contracts, a texture may be perceived when contraction of the smartgel exposes a gap between spacers.

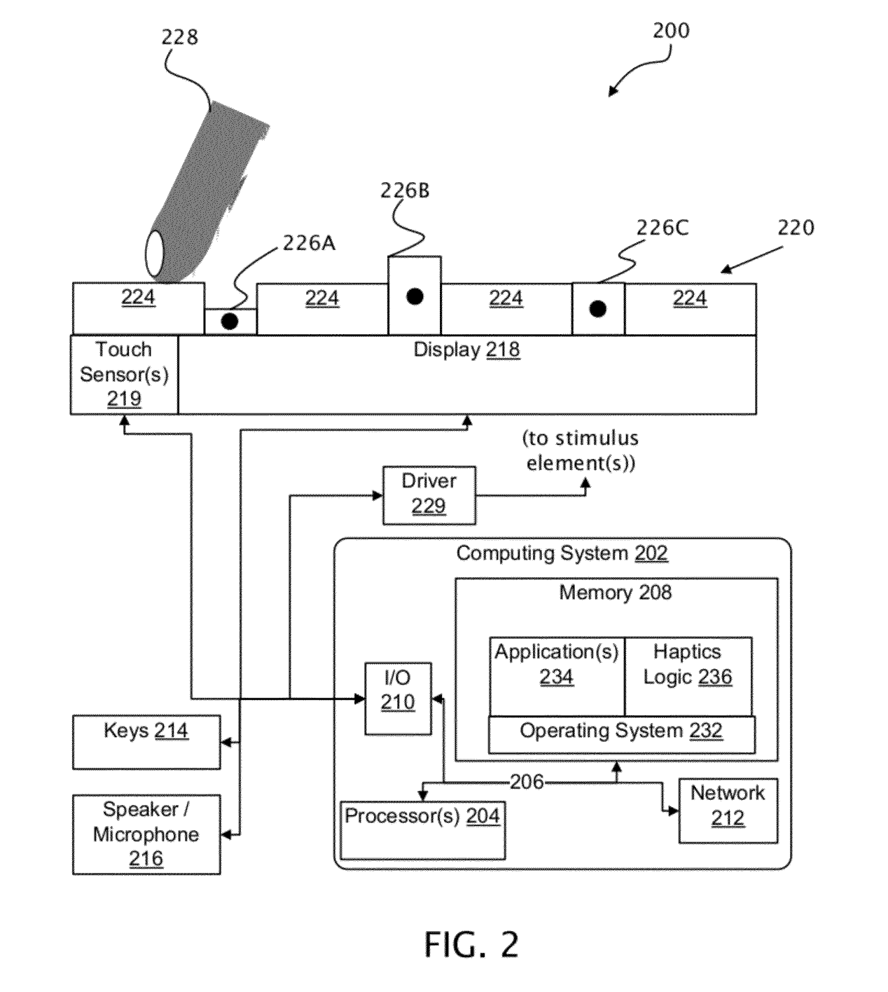

FIG. 2 is a diagram of an illustrative system 200 for providing programmable deformable surfaces. In this example, the system includes a computing system 202 comprising a processor 204 connected via a bus 206 to a memory 208, I/O interface 210, and networking interface 212. For example, I/O interface 210 can be used to connect one or more device keys 214, input/output devices such as a speaker/microphone 216, and display 218. It will be understood that a device may comprise other interface elements (e.g., still or video camera, additional or fewer keys, etc.). System 200 comprise a mobile, desktop, or other computing device (e.g., a “smart phone,” tablet computer, e-book reader, laptop computer, etc.) and in this example features one or more touch sensors 219, which are used in providing a touch-enabled display. Touch sensors 219 may be integrated into display 218, may be positioned below display 218, and/or may be positioned elsewhere to identify a location of one or more touch inputs. For example, resistive, capacitive, optical, and/or other techniques can be used to detect a touch location.

Memory 208 may comprise RAM, ROM, or other memory accessible by processor 204. I/O interface 212 can comprise a graphics interface (e.g., VGA, HDMI) to which display 214A is connected, along with a USB or other interface for connection of input and output devices. Display 218 can use any technology, including, but not limited to, LCD, LED, CRT, and the like. Networking component 212 may comprise an interface for communicating via wired or wireless communication, such as via Ethernet, IEEE 802.11 (Wi-Fi), 802.16 (Wi-Max), Bluetooth, infrared, etc. As another example, networking component 212 may allow for communication over communication networks, such as CDMA, GSM, UMTS, or other cellular communication networks.

In this example, system 200 includes a surface defined by the top of display 218, with a tactile layer 220 disposed on the surface. In some embodiments, the surface may be defined by something other than the display. As one example, an opaque member with suitable touch detection capabilities may define the surface, with tactile layer 220 provided thereon to provide a haptically-enabled track pad mapped to an area of a display device.

In any event, tactile layer 220 comprises a smartgel configured to deform in response to a change in temperature and/or one or more other stimuli. In this example, the tactile layer comprises a plurality of spacers 224 and cells 226, the cells encapsulating the smartgel. The arrangement of cells and spacers can be used to provide edges and other effects by deforming tactile layer to selectively raise and lower portions of tactile layer 220. The deformation occurs due to changes in the state of the smartgel in one or more of cells 226. Changes in tactile layer 220 can be perceived by finger 228 or another object brought into contact with tactile layer 220.

Although deformation in this example includes raising and lowering portions of tactile layer 220, other examples of deformation include situations in which only the stiffness of portions of tactile layer 220 is changed. The change in stiffness can cause a change in how the tactile layer is perceived by a user touching the layer.

Processor 204 is in communication with one or more elements that provide the stimulus (or stimuli) to effect a smartgel response. Processor 204 is configured to determine that a predetermined feature is to be provided using the tactile layer and, in response, generate a signal to stimulate at least one portion of the smartgel in order to provide the predetermined feature.

In one embodiment, the stimulus is a change in temperature, and a heating element (or elements) can be configured to receive an electrical current and to emit thermal energy based on the electrical current. Because the heating element(s) are positioned proximate the tactile layer, by commanding the heating element(s) to provide more or less thermal energy, behavior of the smartgel can be controlled.

In this example, the heating element comprises a plurality of wires embedded in portions 226 of tactile layer 220 and represented in FIG. 2 as a plurality of circles. Additionally or alternatively, a heating element may be positioned between the surface (display 218 in this example) and the tactile layer. Heating wires are shown in this example, but other types of heating elements can be used, such as resistive networks or thermally conductive polymers on or within the display, tactile layer, and/or elsewhere. As another example, a heating element may be positioned proximate the tactile layer so as to direct energy (e.g., infrared, microwave, etc.) onto selected portions of tactile layer 220.

The smartgel may respond to another stimulus. Fox example, NIPAAm-based hydrogels respond to other stimuli, e.g. electrical current, light, salt, and chemical stimuli. Suitable elements can be used to introduce an appropriate stimulus to achieve a response by the smartgel. For instance, if the smartgel deforms as a function of light, the system may include an element to stimulate a smartgel by directing light toward selected portions of tactile layer 220 (or changing characteristics of light otherwise directed toward tactile layer 220). Chemical-based stimuli can be used, such as actuator-driven injection mechanisms to introduce a chemical agent to the smartgel, such as an agent that changes the smartgel pH, introduces a salt, glucose, ions, etc. If electrical-based stimuli are used, the wires or other elements may be embedded in the smartgel or may include electrodes to direct current through the smartgel and/or to apply an electric field to the smartgel.

The processor may directly drive the heating or other stimulus element and/or provide a control signal to a driver 229 for the element(s). If heating wires are used, driver 229 may comprise an amplifier or other device suitable to generate suitable current as noted above. If another heating element is used, driver 229 may be used to provide suitable energy for changing the temperature of the smartgel. If another type of stimulus element is used, driver 229 can provide suitable signals to the stimulus element (e.g., drive signals to a light source, a command to an actuator to introduce the chemical stimulant into the smartgel, etc.).

Memory 208 embodies one or more program components used to configure how processor 204 operates. For instance, an operating system 232, one or more applications 234, and a haptic logic module 236 are shown here. It will be understood that the haptic logic could be included in either or both the applications and operating system.

Generally, one or more components in memory 208 can comprise program code that causes processor 204 to provide output for use in displaying a graphical user interface using display 218 and program code that causes processor 204 to identify an event, such as an event associated with an element of the graphical user interface or another event that occurs in the course of executing an application.

For example, an application may generate a user interface and, according to application logic, change the content of the interface in response to user input and/or external events. Haptic logic module 236 can comprise program code that causes processor 204 determine a desired location in a deformable layer mapped to the display at which a haptic effect is to be provided in response to the event. In this example, the deformable layer is, of course, tactile layer 220 over display 218, but in other embodiments the tactile layer can be separate from the display. Additional program code can cause the processor device to command the stimulus element(s), such as to change a temperature of at least one portion of a smartgel comprised in the deformable layer to provide the haptic effect.

In this example, the haptic effect comprises raising and lowering portions of tactile layer 220, though an effect could comprise only raising or only lowering various portions. Specifically, cell 226A has been lowered relative to the height of spacers 224 by causing the encapsulated smartgel to contract. Cell 226B has been raised relative to the height of spacers 224 by causing the encapsulated smartgel to expand. The height of cell 226C is substantially unchanged relative to spacers 224—this may be achieved by maintaining a particular temperature for the smartgel of cell 226C.

As noted above, in some systems expansion, contraction, and/or other deformations can result from changing the temperature of the smartgel. For example, a temperature-dependent smartgel may be selected so that in a cool state (i.e. no heat applied), the smartgel is in an expanded state, with the cell configured so that its height is the same or nearly the same as spacers 224. If heated, the smartgel may contract as shown in cell 226A. As another example, a smartgel could be selected such that, if heated, it expands as shown at 226B but otherwise remains in a contracted state.

As another example, cell 226B may represent a smartgel in its cooled state, with cell 226C in a first heated state and cell 226A in a second heated state. Still further, the behavior could be reversed—a smartgel may ordinarily be in the state shown at 226A and may expand as shown at 226C and 226B with increasing amounts of heating.

It will be recognized that multiple different smartgels could be used in the same tactile layer or that the same smartgel can be used throughout the tactile layer. Embodiments can provide a variety of effects using different combinations of smartgels corresponding heating/cooling arrangements to controllably deform the tactile layer. Also, in addition to or instead of raising/lowering portions of the tactile layer, the haptic effect could comprise changing stiffness of one or more portions of tactile layer 220 and/or visual properties such as transparency and color. Combinations of smartgels that respond to different types of stimuli could be used as well (e.g., temperature-dependent smartgels used for some portions of a tactile layer, light-dependent smartgels used in a different portion or intermingled with the temperature-dependent smartgels, etc.).

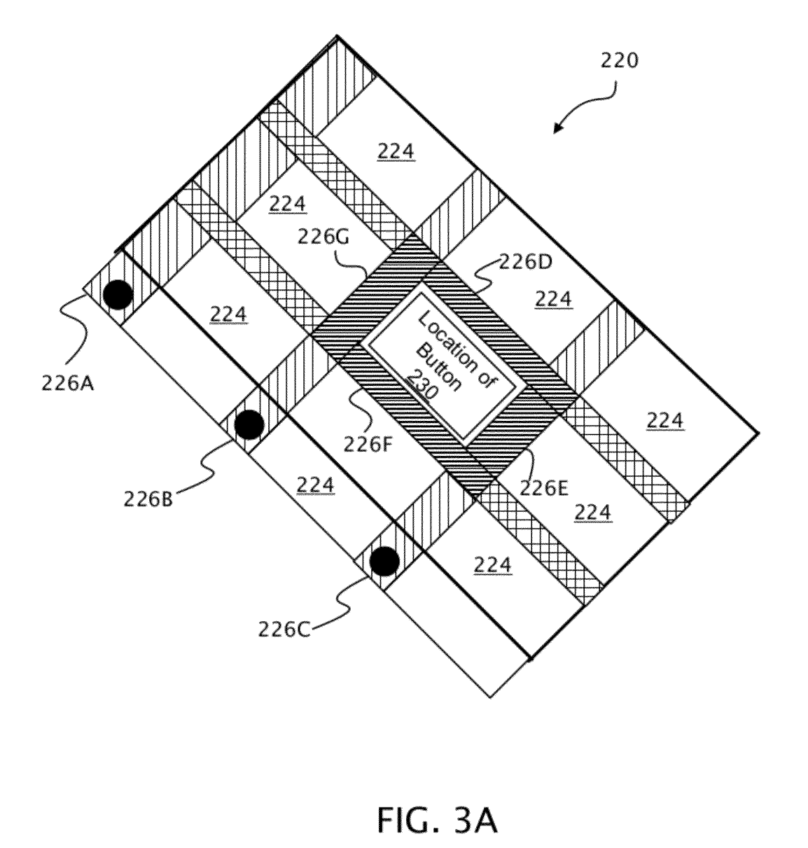

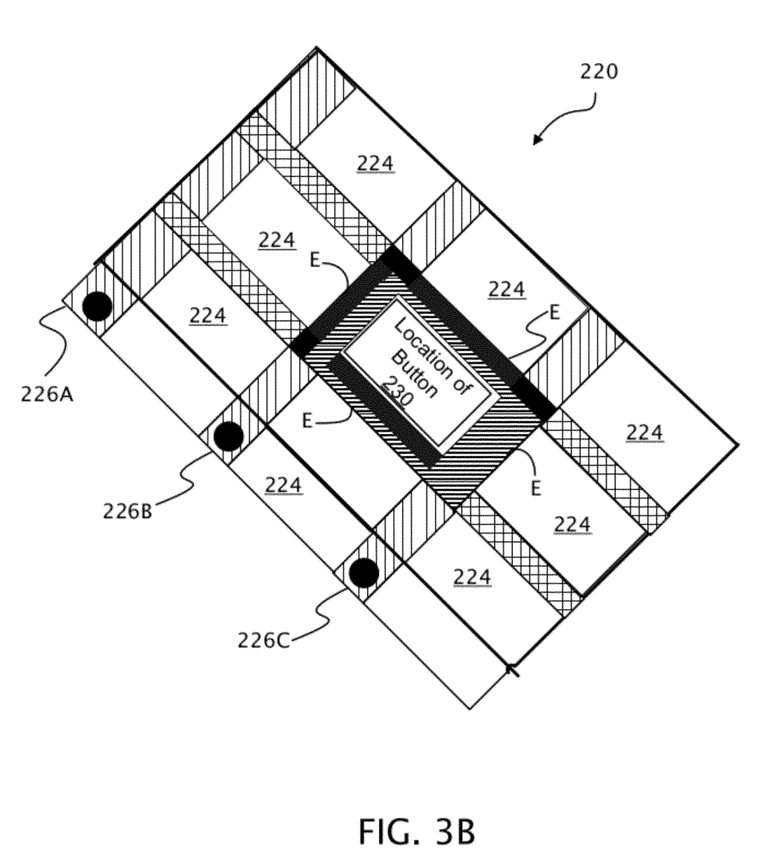

FIGS. 3A-3B illustrate an example of tactile layer 220 before and after deformation to provide a tactile effect. In this example, tactile layer 220 comprises a tiled array of spacers 224 and smartgel cells 226. Again, wires are shown as embedded in cells 226, but it will be understood that other arrangements and/or types of heating or other stimulus elements can be used. In this example, a predetermined feature corresponding to a button 230 is to be provided by selectively deforming portions of smartgel at locations 226D, 226E, 226F, and 226G. These cells are also highlighted by different cross-hatching in FIGS. 3A-3B as compared to other cells not used in this particular example.

The button may be displayed as part of an interface rendered using display 218 (not shown), which may be positioned beneath layer 220. Of course, the same principles applicable in this example are also applicable even if the display were elsewhere, with the location of button 230 in such a case representing an area of a trackpad, mouse, or other input device whose coordinate space is mapped to the area of the display at which button 230 is displayed.

To provide the feature, each cell may be addressed by heating wires associated with that particular cell. As another example, wires embedded in tactile layer 220 may correspond to the edges of button 230 and may be selectively driven to change the temperature of smartgel at 226D-226G. As shown in FIG. 3B, by changing the temperature or otherwise stimulating the smartgel at 226D-226G, gaps are created between the spacer 224 corresponding to button 230 and adjacent spacers 224 when the smartgel contracts. The gaps may be perceived by a user as edges E. In another embodiment, the edge can be generated by using a smartgel that expands in order to provide a raised border around the spacer 224 corresponding to button 230. Other embodiments may use a combination of raising and lowering features to generate edges, ridges, contours, and/or other effects.

The relative size of spacers 224 and cells 226 can vary. For example, spacers 224 may be sized to correspond to typical interface elements, with cells 226 sized to provide a gap (or border) that provides meaningful tactile feedback. As another example, an addressable array of cells only could be used to provide a programmable array of areas that can be raised, lowered, adjusted in stiffness, and/or adjusted in color. For example, cells 226 could have a size “zero,” i.e., a series of very small cells across the layer. As another example, smartgel cells could be included under the spaces as well. Cell sizes and shapes need not be uniform, and some effects can be achieved by configuring the system so that different cells can exhibit a different response to the same stimulus. More generally, the smartgel can be anywhere and addressed arbitrarily.

Still further, the use of cells in this example is not intended to be limiting. For instance, in some embodiments a layer may encapsulate the smartgel, but the gel may not be divided into individual cells. Instead, embedded stimulus elements can be used to selectively raise/lower portions based on the pattern of the embedded heating elements as noted above. For instance, wires may be embedded in a pattern corresponding to various textures, edges of user interface elements, and the like. As another example, a pattern of directed energy can be used to achieve a corresponding pattern of changes in the smartgel.

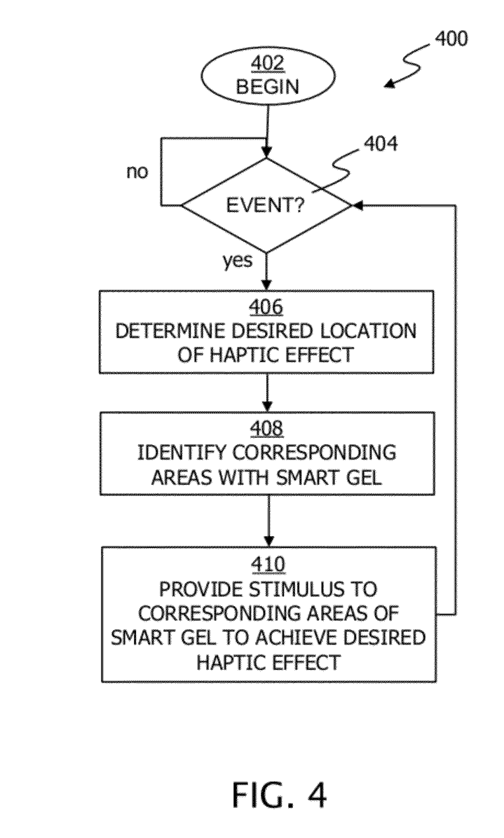

FIG. 4 is a flowchart showing steps in an illustrative method 400 of providing a programmable deformable surface. The method can be carried out by any suitable computing device featuring a processor interfaced with an element that is (or can be) used to stimulate a tactile layer comprising a smartgel. For example, the element could be a heating or cooling element in thermal communication with a tactile layer comprising a smartgel as noted above, and/or may comprise an element positioned to otherwise stimulate the smartgel.

The method begins at block 402. As one example, the method can begin while a computing system is displaying a graphical user interface using a display device. Block 404 represents waiting for an event to occur. The event may, for example, be associated with an element of the graphical user interface. However, another type of event may also trigger progress in the method—for instance, an external event such as receipt of data (e.g., a voice, text, or other message) may be identified. As another example, an internal event, such as another process reaching a specified state (e.g., an alarm clock reaching a specified time, an event occurring during the course of a game, etc.) may be identified as corresponding to a haptic effect.

Block 406 represents determining a desired location in a tactile layer to provide a haptic effect based on the event and block 408 represents identifying corresponding areas of smart gel for use in providing the effect. For example, the effect may be provided by stimulating the corresponding areas in order to raise and/or lower portions of the tactile layer by providing thermal energy and/or another stimulus to the corresponding area(s). Depending upon the state of the tactile layer and the desired effect, this may entail raising or lowering the tactile layer at or near the desired location. However, the desired effect may be achieved by raising or lowering the tactile layer at or near a location apart from the desired location while the tactile layer at the desired location remains substantially unchanged. The tactile layer may be raised and/or lowered by expanding and contracting smartgel as needed, and additionally or alternatively by changing the stiffness of the smartgel.

As another example, the haptic effect may entail changing only the stiffness of the smartgel to render portions of the tactile layer more pliant and/or rigid as the case may be. As a further example, the transparency and/or the color of the smartgel may be changed alongside or instead of expanding, contracting, and/or adjusting stiffness. For instance, a smartgel may change in transparency (and/or color) as it expands, contracts, and/or changes in stiffness, such as a change from a transparent state to a semi-transparent state or to an opaque state. If the smartgel is included in an overlay atop a display, this change may be used to provide a haptic effect with tactile and visual characteristics, such as providing a visible and touchable edge for an on-screen element.

Block 410 represents providing a stimulus to the corresponding areas to achieve the desired haptic effect. As noted above, in some systems the desired haptic effect will depend on the smartgel's response to changes of temperature. The temperature may be changed in any number of ways. For example, heat may be applied to appropriate portions of the smartgel and/or a level of heat applied at the time that the temperature is to be changed can be reduced. The heat can be provided using wires, resistive elements other than wires, and/or directed energy, to name a few examples. Although these examples have referred to use of a “heating element,” embodiments include use of a cooling element to reduce the temperature of the smartgel in a controlled manner. If the smartgel responds to another stimulus, the other stimulus (or stimuli) can be provided to achieve the desired effect, such as by changing light directed at the smartgel, directing a current through the smartgel, applying an electric field to the smartgel, introducing a chemical agent, etc. as discussed above.

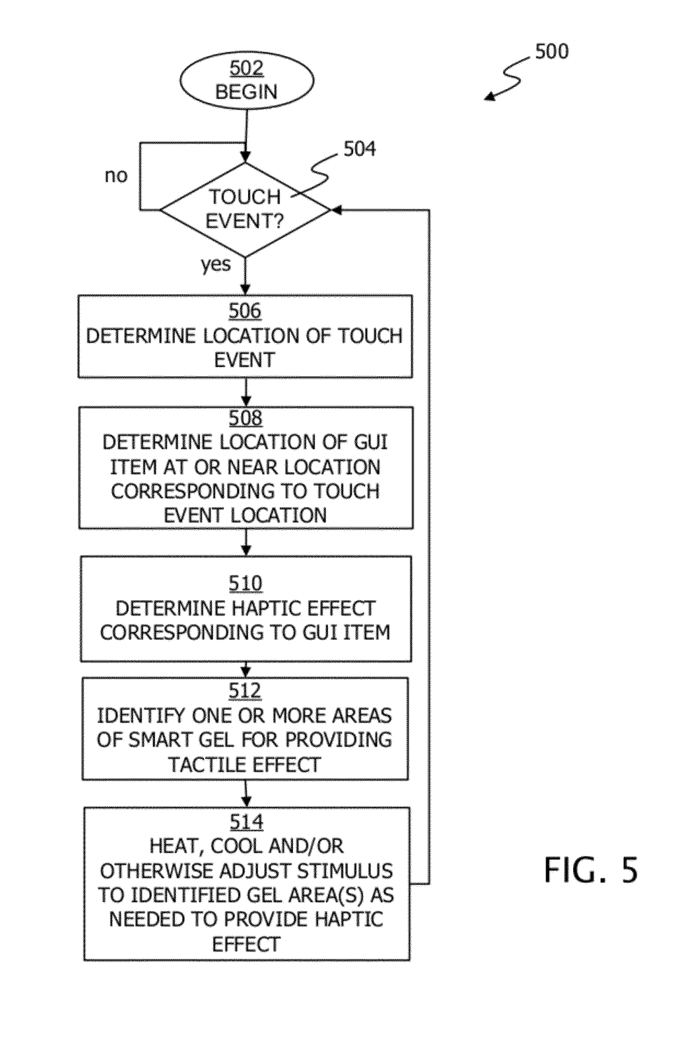

FIG. 5 is a flowchart showing steps in an illustrative method 500 of providing a haptic effect using a programmable deformable surface. In particular, the programmable deformable surface is used in conjunction with a touch-sensitive device, such as a touch-enabled display or another device with a touch-enabled surface. The display or another input device, such as a trackpad, mouse, input surface, or other device, can be used to receive input via one or more touches but can also provide haptic outputs by way of smartgel included in a tactile layer in accordance with the present subject matter.

The method begins at block 502 and then moves to waiting for a touch event at 504. At block 506 the location of the touch event is determined. The touch event may be detected when a user approaches and/or touches the touch-enabled surface, depending on the particular touch detection technology that is used. In this example, the haptic effect that will be provided is based on the location of the touch relative to a location of a graphical user interface item. Specifically, the touch surface can be mapped to locations in a graphical user interface. The mapping may be direct (e.g., a location on a tactile layer atop a display can map directly to the location in the display underneath) or indirect (e.g., locations in a trackpad or other input device may be mapped to a graphical user interface displayed elsewhere with a scaling or other transformation between touch coordinates and display coordinates).

Block 508 represents determining a location of a graphical user interface item at or near a location in the graphical user interface that corresponds to the touch location. For example, the mapping may be used to convert a coordinate value for the touch as provided by the detection system into screen coordinates.

Block 510 represents determining a haptic effect corresponding to the graphical user interface item. One example of a tactile effect is an edge that corresponds to an edge of the item as rendered in the graphical user interface. As an example, the graphical user interface item may comprise a button, slider, checkbox, or other onscreen control element. As another example, the graphical user interface item may comprise a graphic element such as a line, shape, pattern, etc. A corresponding line, shape, or pattern can be provided as a tactile counterpart to the item. A three-dimensional GUI item (or a GUI item displayed using a 3-D effect) may be represented by a three-dimensional tactile profile (e.g., a rounded edge). The tactile effect corresponding to the item can vary, and different items may have unique effects. Additionally, the tactile effect need not map directly to what is shown onscreen—for example, different colors of onscreen items may be associated with different texture patterns or different degrees of stiffness.

Block 512 represents identifying one or more areas of smartgel for use in providing the haptic effect. For instance, if an array of cells and spacers is included in the tactile layer, then the cells that will need deformation can be identified. As noted above, these may be cells corresponding to the location of the tactile feature and/or may be elsewhere in the layer. As another example, areas of smartgel may be identified in terms of particular portions of heating elements or other element(s) used to control one or more stimuli applied to the smartgel. For example, wires embedded in or adjacent to the tactile layer may correspond to particular patterns across the tactile layer. Block 512 can comprise determining which pattern or combination of patterns is to be used to provide the tactile effect at the desired location.

Block 514 represents heating, cooling, and/or otherwise adjusting a stimulus to the identified area(s) of smartgel as needed to provide the tactile effect. For example, particular cells may be heated or cooled by addressing the cells, and/or wires or portions thereof may be driven with current so as to increase or decrease heat in the identified areas. As another example, energy may be directed onto the identified area(s) and/or an existing level of energy directed onto the identified area(s) may be decreased. More generally, a new stimulus can be applied (e.g., heat, light, current, chemical agents, etc.) and/or a characteristic of an ongoing stimulus (e.g., an ambient light level and/or frequency, ambient current, etc.) can be adjusted to effect a response from the smartgel.

The cells may be addressed in some embodiments based on locations of the cells in an array. For example, each cell (or group of cells) in an array of cells may have one or more wires passing through or near the cell (or group of cells). The respective cells (or groups of cells) can be addressed by passing current through the corresponding wire(s). As another example, an array of other elements used to apply another stimulus can be addressed in an analogous fashion.

In one embodiment, the touch event is identified as a user lightly touching the surface while an on-screen keyboard is displayed. A tactile effect is used to provide cues to the user to indicate when his or her touch is over a key. For example, the tactile effect can include simulating key edges and/or ridges or bumps for particular keys (e.g., the “home” keys on a QWERTY or other keyboard, the “5” key in a numeric keypad, etc.).

As another example, key stiffness can be influenced through use of the smartgel by increasing or decreasing stiffness of an area of the tactile layer in response to a user's touch. For example, an area of smartgel may be expanded and increased in stiffness in order to present a button or edge for actuation by a user, or to direct the user to another area of the screen (e.g., a location corresponding to a spacer or a cell that is not increased in stiffness) for actuation. Stiffness can be used alongside raising/lowering features as well.

Although FIG. 5 provided an example in conjunction with a graphical user interface item, haptic effects can be provided in the absence of a graphical user interface. For instance, a haptic-only interface may be presented, with different tactile effects provided in response to user input, different application states, and/or to denote different available controls and actions. For example, a purely tactile implementation could feature a programmable surface used to remotely experience different textures for a chair, seat, table, floor, carpet, clothing item, or other surface. As a particular example, a remote device could be configured to display textures for fabrics or surfaces to assist a user configuring options for an automobile or making another purchase decision.

Several examples above related to embodiments in which a tactile layer is used with a mobile device. However, the principles can be applied regardless of the intended use and/or form factor of a computing device. Additionally, the context or purposes of the computer program employing the haptic effects can vary.

For example, tactile effects can be provided for use with consumer electronics (e.g., media players, gaming systems, televisions, remote control devices, etc.), vehicles (e.g., as part of automotive computing systems, in-car navigation, industrial equipment, etc.) and in desktop computers and computers embedded in other devices (e.g., appliances, kiosks, industrial equipment, medical equipment, etc.). The program(s) employing the haptic effects include (but are not limited to) operating systems, communications applications, games, productivity software, design software, specialized software (e.g., for operating industrial, medical, and other equipment). These and other end uses of the present subject matter will be apparent to one of skill in the art upon review of this disclosure.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with non-transitory computer-readable media storing or otherwise embodying instructions executable by the processor and that can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic storage media, or any other storage medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A system comprising:
a surface;
a tactile layer disposed on the surface and comprising a smartgel, the smartgel configured to deform in response to a stimulus;
a processor; and
an element configured to apply the stimulus in response to a signal from the processor, wherein the processor is configured to:
determine that a predetermined feature is to be provided using the tactile layer, and
command the element to apply the stimulus to cause at least one portion of the smartgel to provide the predetermined feature.

2. The system of claim 1, wherein the predetermined feature comprises at least one of:
a raised surface feature provided by causing at least one portion of the smartgel to expand; or
a lowered surface feature provided by causing at least one portion of the smartgel to contract.

3. The system of claim 1,
wherein the element comprises at least one heating element, the at least one heating element configured to receive an electrical current and to emit thermal energy based on the electrical current,
wherein the at least one heating element is positioned proximate the tactile layer, and
wherein commanding the element to apply the stimulus comprises generating a signal to control the electrical current in the heating element to change a temperature of the at least one portion of the smartgel in order to provide the predetermined feature.

4. The system of claim 3,
wherein the tactile layer comprises a tiled array comprising a plurality of cells and a plurality of spacers, the plurality of cells encapsulating the smartgel,
wherein the processor is configured to identify at least one of the cells as corresponding to the predetermined feature, and
wherein generating a signal comprises controlling the electrical current in the heating element to change a temperature of the smartgel in the identified cell or cells.

5. The system of claim 3, wherein the heating element is arranged to correspond to a pattern of a textured surface.

6. The system of claim 3,
wherein the predetermined feature is an edge of the graphical user interface element,
wherein the heating element comprises a portion corresponding to the edge of the graphical user interface element, and
wherein generating a signal comprises controlling the electrical current in the portion of the heating element corresponding to the edge.

7. The system of claim 1, wherein the tactile layer is substantially transparent and the smartgel is configured to have at least one state during which the smartgel is substantially transparent.

8. The system of claim 7, further comprising a display, wherein the display comprises the surface and images displayed by the display are visible through transparent portions of the overlay.

9. A method, comprising:
displaying a graphical user interface using a display device interfaced to a computing device, the computing device further interfaced with an element configured to apply a stimulus to a tactile layer comprising a smartgel;
identifying an event associated with an element of the graphical user interface;
determining a desired location in a tactile layer to provide a tactile effect, the desired location determined based on the event; and
using the element, applying a stimulus to at least one portion of the smartgel to provide the tactile effect.

10. The method set forth in claim 9,
wherein the tactile effect is provided by raising or lowering the tactile layer at or near the desired location by deforming the at least one portion of the smartgel at the desired location.

11. The method set forth in claim 9,
wherein the tactile effect is provided by raising or lowering the tactile layer at or near a location apart from the desired location by deforming the at least one portion of the smartgel at a location apart from desired location while the tactile layer at the desired location remains substantially unchanged.

12. The method set forth in claim 9,
wherein the event is a touch event and the desired location to provide the tactile effect is at or near a location of the touch.

13. The method set forth in claim 12, wherein the tactile effect corresponds to an edge of a graphical user interface element displayed in the graphical user interface.

14. The method set forth in claim 12, wherein the element comprises a heating element and includes a portion corresponding to the edge, the portion corresponding to the edge used to change a temperature of the smartgel to provide the tactile effect.

15. The method set forth in claim 9, wherein the tactile layer comprises an overlay positioned over the display.

16. The method set forth in claim 9,
wherein the element comprises a heating element,
wherein the smartgel is configured to expand or contract in response to a change in temperature, and
wherein applying the stimulus comprises commanding the heating element to change the temperature of at least one portion of the smartgel.

17. The method of claim 16, wherein the heating element comprises one or more wires, the one or more wires positioned adjacent to or embedded within the tactile layer.

18. The method set forth in claim 16,
wherein the tactile layer comprises a tiled array of cells encapsulating the smartgel and a plurality of spacers, and
wherein changing a temperature of at least one portion of the smartgel comprises using the heating element to change a temperature of selected cells in the tactile layer.

19. The method of claim 9, wherein applying the stimulus comprises at least one of:
introducing a substance into the smartgel;
introducing a current into the smartgel; or
directing light onto the smartgel.

20. A computer program product comprising a non-transitory computer-readable medium embodying program code, the program code comprising:
program code that causes a processing device to provide output for use in displaying a graphical user interface;
program code that causes the processing device to identify an event associated with an element of the graphical user interface;
program code that causes the processing device to determine a desired location in a deformable layer mapped to the display to provide a haptic in response to the event; and
program code that causes the processing device to provide a signal causing at least one portion of a smartgel comprised in the deformable layer to deform to provide the haptic effect.

21. The computer program product set forth in claim 20, wherein providing a signal causing at least one portion of the smartgel to deform comprises commanding a heating element to change a temperature of at least a portion of the smartgel.

22. The computer program product set forth in claim 20, wherein the haptic effect comprises raising or lowering a surface feature of the deformable layer.

23. The computer program product set forth in claim 20, wherein the haptic effect comprises a change in at least one of a visual property of a portion of the deformable layer or a stiffness of the deformable layer.
